(19) United States
(12) Patent Application Publication
(10) Pub. No.: US 2026/0340493 A1
(43) Pub. Date: Oct. 29, 2026

(54) MACHINE LEARNING MODEL WATERMARKING

(71) Applicant: International Business Machines Corporation, Armonk, NY (US)

(72) Inventors: Courtney BRANSON, Arvada, CO (US); Gabriel Idris GILLING, New York, NY (US); Rakshith DASENAHALLI LINGARAJU, Palo Alto, CA (US); Dheeraj ARREMSETTY, Manor, TX (US); Aaron T. SMITH, Raleigh, NC (US)

(21) Appl. No.: 19/191,235

(22) Filed: Apr. 28, 2025

(51) Int. Cl. G06N 20/00; G06F 16/35

(52) U.S. Cl. CPC G06N 20/00; G06F 16/35

(57) ABSTRACT

Methods, computer program products, and systems are presented. The method computer program products, and systems can include, for instance: embedding a plurality of training documents used to train a machine learning model to generate a plurality of training embeddings; clustering the plurality of training embeddings to generate one or more reference centroids, wherein respective ones of the reference centroids represent clusters of semantically similar training embeddings; deploying the machine learning model to a model hosting server configured to serve model inference requests; embedding candidate document data to generate one or more candidate embeddings; comparing the one or more candidate embeddings to the one or more reference centroids using a vector space distance metric; and presenting an indication that the candidate document data is attributable to the machine learning model based on a result of the comparing.

### BACKGROUND

Embodiments herein relate generally to machine learning models (MLMs) and specifically to machine learning model watermarking.

A machine learning model (MLM) is a computational system that learns patterns from data and uses those patterns to make predictions, generate outputs, or classify new information. Rather than being explicitly programmed with rules, an MLM is trained by exposure to large volumes of example data, allowing it to infer statistical relationships and underlying structures. One specialized class of MLMs is the large language model (LLM), which is trained on extensive natural language datasets to perform language-based tasks such as text generation, summarization, translation, and question answering. LLMs are typically implemented using transformer-based deep neural network architectures capable of capturing contextual and semantic relationships across vast spans of text. During training, an LLM learns to predict the next token in a sequence based on surrounding context, adjusting internal parameters—often numbering in the billions—to optimize predictive accuracy. The “large” in LLM refers to both the size of the model (in terms of parameters) and the breadth of training data, which may include books, articles, code, and conversational transcripts. Once trained, an LLM can accept an input prompt and generate coherent, contextually relevant text, making it useful across domains such as search, education, content creation, programming assistance, and customer service automation.

Data structures have been employed for improving operation of computer system. A data structure refers to an organization of data in a computer environment for improved computer system operation. Data structure types include containers, lists, stacks, queues, tables, and graphs. Data structures have been employed for improved computer system operation e.g., in terms of algorithm efficiency, memory usage efficiency, maintainability, and reliability.

Artificial intelligence (AI) refers to intelligence exhibited by machines. Artificial intelligence (AI) research includes search and mathematical optimization, neural networks and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided, through the provision, in one aspect, of a method. The method can include, for example: embedding a plurality of training documents used to train a machine learning model to generate a plurality of training embeddings; clustering the plurality of training embeddings to generate one or more reference centroids, wherein respective ones of the reference centroids represent clusters of semantically similar training embeddings; deploying the machine learning model to a model hosting server configured to serve model inference requests; embedding candidate document data to generate one or more candidate embeddings; comparing the one or more candidate embeddings to the one or more reference centroids using a vector space distance metric; and presenting an indication that the candidate document data is attributable to the machine learning model based on a result of the comparing.

In another aspect, a computer program product can be provided. The computer program product can include a computer readable storage medium readable by one or more processing circuit and storing instructions for execution by one or more processor for performing a method. The method can include, for example: embedding a plurality of training documents used to train a machine learning model to generate a plurality of training embeddings; clustering the plurality of training embeddings to generate one or more reference centroids, wherein respective ones of the reference centroids represent clusters of semantically similar training embeddings; deploying the machine learning model to a model hosting server configured to serve model inference requests; embedding candidate document data to generate one or more candidate embeddings; comparing the one or more candidate embeddings to the one or more reference centroids using a vector space distance metric; and presenting an indication that the candidate document data is attributable to the machine learning model based on a result of the comparing.

In a further aspect, a system can be provided. The system can include, for example, a memory. In addition, the system can include one or more processor in communication with the memory. Further, the system can include program instructions executable by the one or more processor via the memory to perform a method. The method can include, for example: embedding a plurality of training documents used to train a machine learning model to generate a plurality of training embeddings; clustering the plurality of training embeddings to generate one or more reference centroids, wherein respective ones of the reference centroids represent clusters of semantically similar training embeddings; deploying the machine learning model to a model hosting server configured to serve model inference requests; embedding candidate document data to generate one or more candidate embeddings; comparing the one or more candidate embeddings to the one or more reference centroids using a vector space distance metric; and presenting an indication that the candidate document data is attributable to the machine learning model based on a result of the comparing.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having a manager system, user equipment (UE) devices, model hosting servers and enterprise systems according to one embodiment;

FIG. 2 is a flowchart illustrating a method for performance by a manager system interoperating with enterprise systems, content management servers, model hosting servers, and UE devices according to one embodiment;

FIG. 3 is a schematic diagram illustrating training data embedding and clustering according to one embodiment;

FIG. 4 is a schematic diagram illustrating training data embedding and clustering according to one embodiment;

FIG. 5 is a schematic diagram illustrating candidate document data embedding and comparing according to one embodiment;

FIG. 6 is a schematic diagram illustrating candidate document data embedding, clustering and comparing according to one embodiment;

FIG. 7 depicts an artificial neural network (ANN) according to one embodiment;

FIG. 8 depicts a computing environment according to one embodiment.

### DETAILED DESCRIPTION

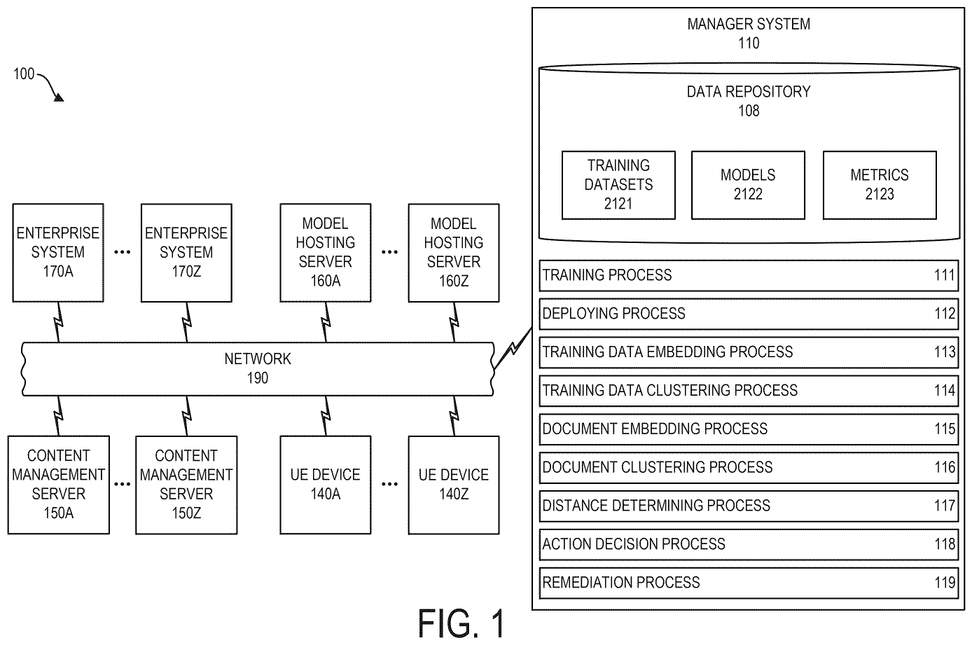

System for remediating unauthorized model usage is set forth in reference to FIG. 1. The system can include manager system 110 having an associated data repository 108, user equipment (UE) devices 140A-140Z, content management servers 150A-150Z, model hosting servers 160A-160Z, and enterprise systems 170A-170Z. Manager system 110, UE devices 140A-140Z, content management servers 150A-150Z, model hosting servers 160A-160Z, and enterprise systems 170A-170Z can be computing node-based systems connected in communication with one another via network 190. Network 190 can be a physical network and/or a virtual network. A physical network can be, for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network.

Manager system 110, in one embodiment, can be external to each UE device of UE devices 140A-140Z, each content management server of content management servers 150A-150Z, each model hosting server of model hosting servers 160A-160Z, and each enterprise system of enterprise systems 170A-170Z. In another embodiment, manager system 110 can be collocated with one or more UE device 140A-140Z and/or one or more content management server 150A-150Z, and/or one or more model hosting server 160A-160Z, and/or one or more enterprise system of enterprise systems 170A-170Z.

Embodiments herein recognize that the proliferation of Large Language Models (LLMs) has ushered in significant advancements in automated content generation, yet it has simultaneously introduced pressing risks, including the generation of disinformation, unauthorized reproduction of proprietary models, and misuse in educational or professional settings. Conventional watermarking approaches typically require modification of the LLM architecture or token-generation process, imposing limitations on performance, fidelity, and backward compatibility.

Embodiments herein address the unmet need for a transparent, non-intrusive, and computationally efficient mechanism to determine whether a specific LLM generated a given output. It enables a posteriori attribution of LLM-generated content by leveraging embedding-based clustering of both the training data and generated output to establish statistical centroids. By comparing the distances between centroids, the invention offers a robust and model-agnostic watermarking system that improves computer security and traceability in AI-generated text pipelines-advancing the field of machine learning infrastructure and digital content attribution without modifying the underlying LLM architecture.

Embodiments herein relate generally to artificial intelligence, and more particularly to techniques for watermarking and verifying attribution of text generated by large language models (LLMs) using non-intrusive centroid-based clustering of training and output data embeddings.

Embodiments herein improve the attribution and traceability of LLM-generated text by constructing embedding-based centroids from both the LLM's training data and its output, then computing distances between such centroids using clustering algorithms such as K-means or DBSCAN. The resulting inter-centroid distances serve as statistical fingerprints or watermark signatures of the originating model. Unknown content can later be analyzed using the same embedding and clustering technique to compute centroid distances and determine, with high probability, whether the text originated from the specific LLM. The invention thus enables non-invasive watermarking that supports enhanced computational integrity, AI governance, and model security.

Data repository 108 can store various data. Data repository 108 in training datasets area 2121 can store datasets for use in training one or more predictive model. Manager system 110 can acquire training datasets, e.g., from enterprise systems of enterprise systems 170A-170Z or from other data sources.

Data repository 108 in models area 2122 can store one or more predictive models. Models in models area 2122 can include large language models (LLMs). A large language model (LLM) is a type of machine learning model trained on extensive collections of natural language data to perform a variety of language-related tasks, such as text generation, summarization, translation, classification, question answering, and interactive dialogue. LLMs are typically built using deep neural network architectures, most commonly transformers, which are capable of capturing complex relationships between words and phrases by processing input text as sequences of tokens. These models operate by predicting the next token in a sequence based on the preceding context, enabling them to generate coherent and contextually relevant responses. The term “large” generally refers to the size of the model in terms of both the volume of training data and the number of learnable parameters, which can scale from millions to hundreds of billions, depending on the implementation. LLMs are trained in a self-supervised fashion, learning to infer structure and meaning from raw text without requiring manually labeled data. Once trained, an LLM is typically accessed via a prompt—a user-provided input string that directs the model's behavior. The model processes the prompt within a fixed-length context window, which can impose limits on how much information it can consider at once. Use cases can span across domains and industries, and model behavior may be shaped further through fine-tuning or prompt engineering.

Data repository 108 in metrics area 2123 can store metrics generated by manager system 110. Metrics area 2123 can store metrics generated for determination of attributions with respect to one or more predictive model. Embodiments herein recognize that predictive models, such as large language models (LLMs), may be used without proper authorization, including in cases where content is generated using a model not approved for use in a particular environment. Embodiments herein provide methods for attributing generated content to one or more predictive models to determine its source. When manager system 110 determines that the attributes of a given content item indicate generation by a predictive model that is not authorized for use, the system can return an action decision to support remediation of the unauthorized use, including alerting, blocking, or initiating further policy-driven responses.

Manager system 110 can run various processes. Manager system 110 running training process 111 can train one or more predictive models of models area 2122.

Manager system 110 running training process 111 can include manager system 110 acquiring training data from one or more enterprise system of enterprise systems 170A-170Z and/or one or more alternative data source, and applying the training data to train one or more predictive model including one or more LLM for storage into models area 2122. On acquiring of training datasets for training one or more model, manager system 110 can store and retain training data into training datasets area 2121 and can associate each training dataset of training datasets area 2121 to the one or more model trained by the respective training datasets. On completion of training of a predictive model, manager system 110, by running of training process 111, can store the trained model into models area 2122.

Manager system 110, on completing training of one or more predictive model, can deploy the one or more predictive model by running deploying process 112. Manager system 110 running deploying process 112 can include the manager system deploying a trained model of models area 2122 to one or more model hosting server 160A-160Z. Model hosting servers can have certain characteristics. A suitable model hosting server, such as one used for deploying large language models (LLMs), can be characterized by a range of features that support efficient, flexible, and scalable operation. The server can be equipped with high-performance computing resources, including CPUs, substantial RAM, and optionally one or more GPUs or AI accelerators that can enable rapid parallel processing. It can include storage systems capable of handling large-scale model files and associated datasets, which can span hundreds of gigabytes or more. The server can support low-latency networking to facilitate responsive interaction, especially in real-time applications, and can include load balancing mechanisms to handle variable request volumes. It can be compatible with widely used machine learning frameworks and model formats, allowing models trained in environments such as PyTorch, TensorFlow, or ONNX to be easily deployed. Containerization and orchestration tools such as Docker and Kubernetes can be used to support dynamic scaling and streamlined maintenance. The server can also include access controls, encryption, and audit logging to support secure and compliant use in enterprise environments. Monitoring tools can be employed to track usage, performance, and operational metrics, allowing system administrators to optimize model deployment and resource allocation according to workload demands.

Manager system 110 running training data embedding process 113 can include manager system 110, for respective models of models area 2122, processing training data, e.g., sample training data of a respective training set of dataset used for training the respective models. Manager system 110 running training data embedding process 113 can, for a particular training dataset used for training a certain model, sample training data, e.g., training data documents defining the training dataset. Manager system 110 running training data embedding process 113 can generate one or more vector embedding for each training data document in the described scenario. On generating an embedding for a training data document, manager system 110 running training data embedding process 113 can store the output embedding into metrics area 2123. Manager system 110 running training data embedding process 113 can include manager system 110 generating vector representations (embeddings) for text-based training documents by applying a pre-trained language model (e.g., BERT™, GPT®, Sentence-BERT™). The system may embed the entire training dataset or a representative sample, depending on computational resources and model requirements. For each document, the manager system may generate a single embedding vector (e.g., by pooling over tokens), or multiple vectors per document (e.g., token-wise embeddings), depending on the use case.

Manager system 110 running training data clustering process 114 can perform clustering analytics with respect to embeddings output by manager system 110 running training data embedding process 113. Manager system 110 running training data clustering process 114 can include manager system 110 outputting embeddings from training data embedding process 113 to a clustering vector space and determining, via clustering analysis, one or more cluster from the vector space. Manager system 110 running training data clustering process 114 can further include manager system 110 determining a centroid for respective clusters identified by manager system 110 running training data clustering process 114.

Manager system 110 running training data clustering process 114 can include manager system 110 performing clustering (e.g., K-means) on the set of training document embeddings to group semantically similar vectors. The output may include a single centroid representing the full training dataset, or multiple centroids to reflect semantically distinct domains within the dataset. Using multiple centroids is helpful when the training data spans diverse subject areas or writing styles (e.g., medical vs. legal vs. code documentation).

Manager system 110 running candidate document embedding process 115 can include manager system 110 performing embedding on one or more candidate documents by generating semantic vector representations using the same embedding model applied to training data. Each candidate document can yield a single embedding or multiple embeddings, depending on content structure and use case.

Manager system 110 running candidate document clustering process 116 can include manager system 110 performing clustering on the embeddings output by candidate document embedding process 115—if multiple embeddings are present—to compute one or more centroids. These centroids can be used for comparison against watermark centroids to assess whether the candidate content likely originated from a watermarked model.

Manager system 110 running distance determining process 117 can include manager system 110 determining a distance between one or more centroid output by manager system 110 running training data clustering process 114, and one or more data point output by manager system 110 running document clustering process 116. Manager system 110 running distance determining process 117 can, e.g., compare an output distance to a threshold distance.

Manager system 110 running action decision process 118 can include manager system 110 returning an action decision in dependence on a result of manager system 110 running distance determining process 117. Manager system 110 running remediation process 119 can include manager system 110 remediating suspected unauthorized use of a model, e.g., LLM, in accordance with an action decision rendered by manager system 110 running action decision process 118.

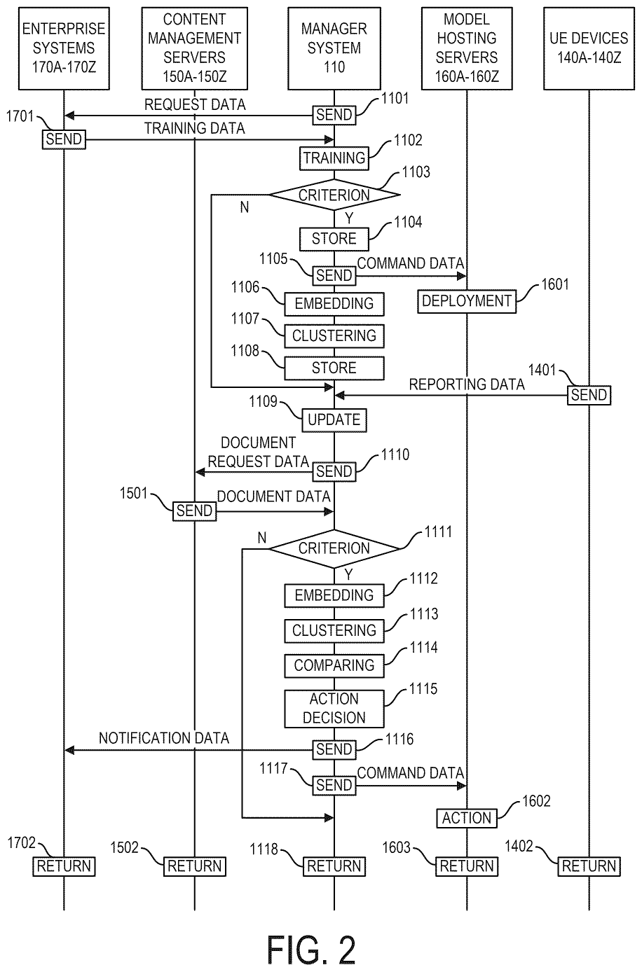

A method for performance by manager system 110 interoperating with enterprise systems 170A-170Z, content management servers 150A-150Z, model hosting servers 160A-160Z, and UE devices 140A-140Z is set forth in reference to the flowchart of FIG. 2.

At block 1101, manager system 110 can be sending request data to enterprise systems 170A-170Z, requesting training data for use in training one or more predictive models. Enterprise systems 170A-170Z can include service providers that supply training datasets, as well as enterprises operating within specific market domains. In some use cases, the enterprise systems can specialize in curating or generating training data, while in others, they can represent organizations within a particular industry sector from which relevant training data can be obtained.

In response to the request data sent at block 1101, enterprise systems of enterprise systems 170A-170Z at send block 1701 can be sending training data for receipt by manager system 110. On receipt of the training data sent at block 1701, manager system 110 can store the received training data into training datasets area 2121 with associated flags that specify the model associated with the various training data. On receipt of the training data sent at block 1701, manager system 110 can perform training at training block 1102. At training block 1102, manager system 110 can be training one or more predictive model, e.g., one or more LLM.

Training a large language model (LLM) can be performed by exposing the model to large-scale corpora of text data and optimizing it to learn patterns in language using deep learning techniques. The training process can be based on a self-supervised learning approach, where the model learns to predict parts of text without requiring manually labeled data. For example, the model can be trained to predict the next token in a sequence (autoregressive training) or to fill in masked tokens (masked language modeling), using only the surrounding context as input. This allows the model to learn grammatical structure, semantic meaning, and contextual relationships. The architecture used for training can be a transformer model, which can rely on attention mechanisms to capture dependencies across long sequences of tokens. The training can involve updating billions of parameters using gradient-based optimization methods, such as Adam or its variants, and can span multiple epochs over vast datasets. Training can be performed on large compute clusters with GPUs or specialized hardware accelerators. Once trained, the model can be used as-is or further fine-tuned on specific tasks or domains. The result can be a model that is capable of performing a wide range of natural language understanding and generation tasks from general or domain-specific prompts.

On completion of training block 1102, manager system 110 can proceed to decision criterion block 1103. At criterion block 1103, manager system 110 can ascertain whether the one or more model subject to training at training block 1102 is ready for storage and deployment. At criterion block 1103, manager system 110 can test, e.g., accuracy of the model using holdout data. An LLM can be tested for deployment readiness by evaluating its performance across a range of benchmark tasks, including text generation, question answering, summarization, and classification. Testing can include both quantitative metrics, such as accuracy, BLEU, or perplexity, and qualitative assessments based on human review. The model can also be assessed for bias, robustness to adversarial inputs, and compliance with usage constraints. Deployment readiness can further depend on latency, scalability, and token efficiency under expected workloads.

On completion of criterion block 1103, and on determining that one or more trained model is ready for storage and deployment, manager system 110 can proceed to store block 1104. At store block 1104, manager system 110 can store the trained and qualified model to models area 2122 for deployment. On completion at store block 1104, manager system 110 can store flags into training datasets area 2121, qualifying that certain datasets having associated models qualified for deployment have been qualified. On completion of store block 1104, manager system 110 can proceed to send block 1105.

At send block 1105, manager system 110 can send command data commanding deployment of the trained model to one or more model hosting servers 160A-160Z. A suitable model hosting server for deploying machine learning models, such as large language models (LLMs), can be designed to support efficient, scalable, and responsive inference. It can include high-performance CPUs and optionally GPUs or other accelerators to handle the compute demands of model execution. The server can be provisioned with sufficient RAM to accommodate large model parameters and manage concurrent request handling. Fast storage, such as solid-state drives, can be used for quick access to model files and runtime data. The server can support low-latency networking to ensure prompt responses, particularly in real-time applications. It can also support containerization and orchestration tools such as Docker and Kubernetes to enable flexible deployment, updates, and load management. Security features like access controls, encryption, and logging can be incorporated to maintain model integrity and traceability. The hosting environment can also support integration with APIs or services for delivering model outputs to downstream applications. Overall, a suitable server can balance compute power, memory, storage, and network responsiveness to reliably host machine learning models in production settings.

The command data sent at send block 1105 can include data specifying the parameters for hosting as well as file data defining the trained model. On receipt of the command data sent at block 1105, model hosting servers 160A-160Z can perform deployment of the trained model at deployment block 1601.

On completion of send block 1105, manager system 110 can proceed to embedding block 1106. At embedding block 1106, manager system 110 can perform vector embedding of training data used for training one or more qualified predictive model deployed at send block 1105. Manager system 110 performing embedding at block 1106 can include manager system 110 generating one or more vector representing training data defined by one or more training documents. On completion of embedding block 1106, manager system 110 can proceed to clustering block 1107.

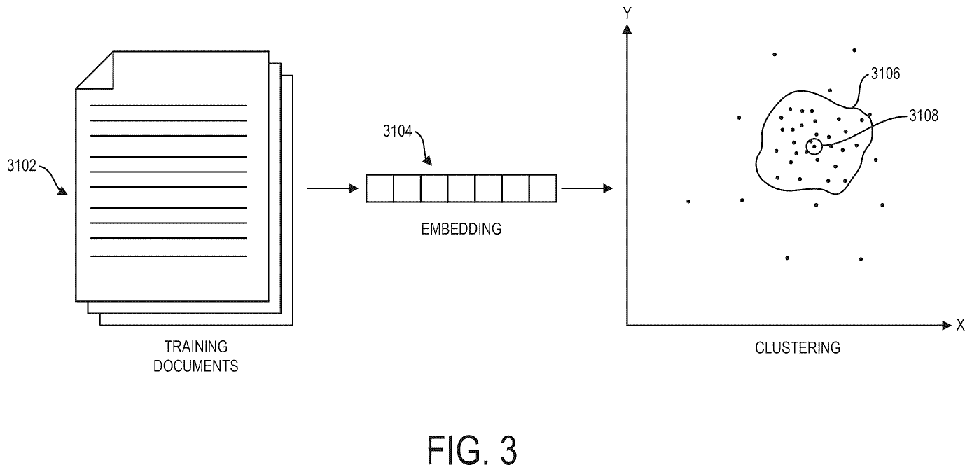

At clustering block 1107, manager system 110 can perform clustering analysis on the embeddings output by embedding block 1106. Manager system 110 performing embedding and clustering is set forth, in one embodiment, in reference to FIG. 3.

Manager system 110 can be configured to perform embedding of text-based training documents at embedding block 1106 in order to generate numerical representations of their semantic content. This embedding process can be a foundational step in generating reference data structures—such as centroids—for use in watermarking, attribution, and unauthorized model use detection.

Manager system 110 at embedding block 1106 can begin by selecting training data used in connection with a large language model (LLM). The selected training data can include the entire set of documents used to train the model or a representative subset thereof. In one use case, manager system 110 can operate over the entire training corpus to capture a complete semantic profile of the model. In other use cases, manager system 110 can operate on a reduced or pre-processed set of training data, particularly in scenarios where compute or memory constraints are present. Preprocessing steps can include tokenization, normalization, lemmatization, and the removal of stop words, though such steps can be omitted when preservation of full semantic context is prioritized.

To perform embedding at embedding block 1106, manager system 110 can process each training document using a transformer-based language model, such as BERT™, GPT®, ROBERTa™, or Sentence-BERT™. The embedding model can be applied at the token, sentence, paragraph, or full document level. For each input document, manager system 110 can generate one or more high-dimensional vector embeddings that reflect the semantic structure of the input text.

In one use case, manager system 110 can generate a single embedding vector per training document. This can be accomplished by aggregating token-level embeddings using mean pooling, max pooling, or by extracting a special pooled token (e.g., the [CLS] token in BERT™). The resulting vector can serve as a compact, fixed-size representation of the document's semantic meaning. In another use case, manager system 110 can generate multiple embeddings per document, for example, one per sentence, paragraph, or token sequence. This multi-vector approach can be advantageous in cases where documents include multiple subtopics, thematic transitions, or structurally distinct sections. The ability to preserve internal document variability can be useful in downstream tasks requiring fine-grained semantic resolution.

Once embedding is complete, manager system 110 can proceed to clustering block 1107. At clustering block 1107, manager system 110 can perform clustering operations on the set of output vectors generated during the embedding step. Clustering can be used to group semantically similar vectors into one or more clusters, each of which can be defined by a centroid. A centroid, in this context, can be a vector that represents the geometric center of the embedding vectors assigned to a particular cluster in the high-dimensional vector space.

To perform clustering at clustering block 1107, manager system 110 can apply a clustering algorithm such as K-means, DBSCAN, or hierarchical agglomerative clustering. In one use case, manager system 110 can perform K-means clustering, specifying a value for K that corresponds to the desired number of clusters. The value of K can be determined using a heuristic such as the elbow method. In some embodiments, manager system 110 can repeat the clustering process multiple times—e.g., using a k-fold strategy—and compute average centroid coordinates across runs to reduce variance and improve robustness. In another use case, manager system 110 can perform density-based clustering (e.g., DBSCAN) to detect natural groupings of vectors without requiring a predefined number of clusters.

The number of centroids generated by manager system 110 can vary depending on the characteristics of the training data. In one use case, manager system 110 can generate a single centroid, e.g., calculated as the mean of all document-level embeddings. This single centroid can serve as a global semantic fingerprint of the training data. Such an approach can be suitable when the training corpus is semantically homogeneous—for example, if the documents pertain to a single domain such as legal contracts, customer service dialogs, or medical transcriptions.

In another use case, manager system 110 can generate multiple centroids, each corresponding to a semantically distinct subgroup within the training data. For example, if the training dataset includes documents from multiple subject domains—such as legal, scientific, financial, and technical texts—then manager system 110 can identify distinct clusters and produce separate centroids for each domain. These domain-specific centroids can enable more precise attribution when analyzing suspected documents that exhibit domain-specific language characteristics. The use of multiple centroids can also support enhanced attribution confidence by allowing comparison against the most relevant centroid subset, rather than a diluted global average.

In summary, manager system 110 can be configured to perform embedding at embedding block 1106 by generating one or more vector representations per training document using a language model. The resulting vectors can be subjected to clustering at clustering block 1107 to generate one or more centroids, which can serve as semantic reference signatures for the model's training data. The choice between generating a single centroid or multiple centroids can be influenced by the topical diversity of the training dataset and the level of granularity required for downstream tasks such as attribution, detection of unauthorized model use, or semantic fingerprinting.

In a simple use case, manager system 110 can be configured to calculate a single centroid per model during embedding block 1106. In this scenario, the training data used to build a particular large language model (LLM) may be relatively homogeneous—such as a corpus composed entirely of legal contracts, customer support transcripts, or medical records. Manager system 110 can apply a transformer-based embedding model, such as BERT™ or Sentence-BERT™, to generate a semantic vector for each training document. These document-level embeddings are then passed to a clustering algorithm, such as K-means with K=1, to compute a single centroid representing the global semantic fingerprint of the model's training data. This centroid serves as a statistical watermark for the model, capturing the average semantic characteristics of its underlying corpus. Later, when a candidate document is embedded, its semantic distance to this centroid can be computed to determine whether it was likely generated by the same model.

In more complex use cases, manager system 110 at embedding block 1106 can be configured to generate multiple centroids per model, where each centroid corresponds to a different subject matter domain found within the model's training data. This approach can be used when the training corpus is semantically diverse and contains content spanning distinct domains such as legal, financial, technical, and conversational texts. Manager system 110 can embed each training document into a high-dimensional semantic vector using a language model such as ROBERTa™ or GPT®. These embeddings can be projected into vector space and subjected to a clustering process—such as K-means with a variable K, or DBSCAN—to identify natural groupings of semantically similar vectors.

Each cluster of vectors discovered in this manner can be interpreted as representing a distinct semantic region, often aligned with a specific subject area or writing style. Manager system 110 can compute a separate centroid for each of these clusters. These domain-specific centroids can be stored as part of the model's watermark in metrics area 2123, forming a richer and more granular fingerprint of the model's semantic training space.

By using multiple centroids, manager system 110 can better accommodate candidate documents that reflect only a portion of the model's overall training distribution. For example, if a document contains legal terminology and stylistic patterns, its embedding may fall closest to the centroid derived from the legal training subset, rather than to an overall average. This enhances attribution sensitivity and enables manager system 110 to make more accurate determinations when evaluating content for potential unauthorized model use.

The clustering configuration at embedding block 1106 can be further refined by applying k-fold clustering to reduce variance, or by using heuristics such as the elbow method to select an appropriate number of clusters. Ultimately, this multi-centroid framework supports domain-aware watermarking, allowing manager system 110 to preserve semantic structure across subject-specific regions of the training data, and improving the system's ability to detect unauthorized generation across a broad range of use contexts.

A watermark for a model, e.g., LLM, can be defined as one or more centroids in semantic vector space, generated by embedding and clustering the training documents used to build the language model. These centroids serve as a statistical fingerprint of the training data and enable attribution by comparing them to centroids derived from suspect content.

In the clustering diagram of FIG. 3, each data point represents a single vector embedding 3104 generated by manager system 110 from a respective training document. Once the document embeddings are projected into vector space, manager system 110 can apply clustering analysis to identify one or more coherent groupings of semantically similar vectors. Within each such grouping, manager system 110 can compute a centroid that reflects the geometric center of the cluster in high-dimensional semantic space. In the depicted example, manager system 110 identifies a cluster 3106 and calculates a corresponding centroid 3108. The centroid 3108 defines the watermark for the training data associated with the deployed predictive model—e.g., an LLM. This centroid represents a compressed semantic fingerprint of the model's training foundation and can be used to verify whether future content exhibits statistical proximity to that training data. The centroid does not encode surface-level token sequences or lexical structure, but instead captures higher-order semantic relationships derived from the embedding model and preserved through clustering. In this embodiment, training documents 3102 may represent a subset or the entirety of the training dataset used to train the model deployed at send block 1105. The watermark created by centroid 3108 enables manager system 110 to later determine, based on distance analysis, whether a suspect document likely originated from the same model by evaluating its proximity to the known training centroid. In response to performing the distance analysis, the manager system 110 generates and presents via an output element of the computer an indication of the determination, e.g., that the first suspect document likely originated from the same model but that a second suspect document did not likely originate from the same model. Such presentation is in various embodiments in the form of a message displayed on a display screen of the computer, an audio message played by a speaker of the computer, and/or via some other output device of the computer.

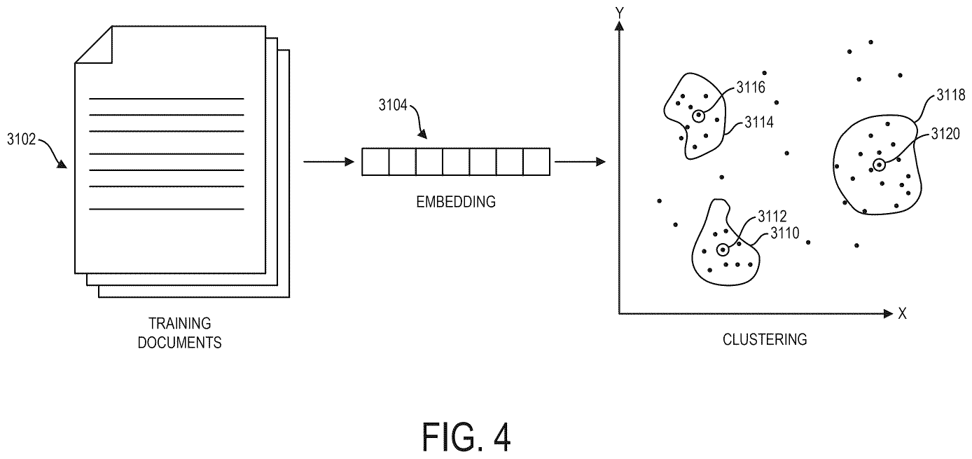

Another embodiment is illustrated in FIG. 4, in which manager system 110 performs clustering on the projected training document embeddings and identifies multiple distinct clusters. This approach can be used when the training dataset encompasses a variety of subject matter domains or heterogeneous language styles. For example, if the training corpus includes legal texts, financial records, customer support dialogues, and software documentation, then manager system 110 may identify corresponding semantically distinct regions in vector space. In such a case, manager system 110 can compute a separate centroid for each identified region, reflecting the semantic center of that subdomain. Referring to FIG. 4, manager system 110 identifies cluster 3110 and its centroid 3112, cluster 3114 and its centroid 3116, and cluster 3118 and its centroid 3120. The centroids 3112, 3116, and 3120 collectively define the watermark for the LLM trained using documents 3102. Each centroid reflects the semantic signature of a particular subdomain or discourse mode within the broader training dataset. By preserving these multiple centroids, the watermark enables domain-aware attribution analysis, in which suspect content can be compared against a relevant subdomain centroid rather than a single global reference. This multi-centroid structure enhances both attribution sensitivity and precision, particularly when dealing with documents that exhibit distinct domain characteristics. The use of multiple centroids can also mitigate the dilution effect that might arise from collapsing a heterogeneous training set into a single centroid, thereby preserving semantic integrity across subject-specific clusters.

Results data resulting from manager system 110 performing embedding at block 1106 and clustering at block 1107 can be stored into metrics area 2123 at store block 1108. On completion of store block 1108, manager system 110 can proceed to update block 1109. At update block 1109, manager system 110 can update, e.g., in models area 2122, an evolving list specifying content management servers to check for unauthorized use of a deployed model.

In one embodiment, manager system 110 and its associated data repository 108 can define a logically distinct and technically dedicated computing environment for generating, storing, and maintaining attribution reference data—specifically the embeddings and clustering centroids computed during blocks 1106 and 1107. This environment, referred to herein as a secure watermark storage and attribution subsystem, can be architected as a self-contained computing enclave that operates independently from the live model hosting infrastructure used to serve the trained model to end users. Manager system 110 can be configured to execute embedding and clustering operations within this subsystem, wherein the resulting high-dimensional vector embeddings of training data and their corresponding semantic centroids are persisted within designated portions of data repository 108—specifically, within a metrics area configured to store attribution-specific data artifacts. Unlike the model itself, which may be deployed via containers to model hosting servers 160A-160Z across a distributed production network, the attribution subsystem can reside in a separate, secured development or test environment optimized for data integrity, computational reproducibility, and offline analytics.

This watermark storage subsystem defined by manager system 110 and repository 108 can serve as a persistent, isolated semantic fingerprint registry, purpose-built for attribution governance. The physical infrastructure supporting the subsystem may be separate from production inference systems—e.g., located on a hardened internal cluster, private virtual network, or cloud instance with limited or no external ingress—and configured with restricted write access to ensure that the attribution data structures are immutable once generated. Repository 108 can enforce version control over centroid data and embedding models, associate them with corresponding training dataset identifiers, and enable deterministic recreation or recalibration of the semantic reference space used for attribution. Because this environment does not carry user-facing model APIs, inference request pipelines, or dynamic scaling logic, it can be configured specifically for embedding compute loads, clustering iterations, statistical distance modeling, and temporal attribution drift analysis without the latency, concurrency, or runtime constraints associated with production inference environments.

The result is a technically advantageous computing architecture wherein manager system 110, through configuration and execution of watermark storage and analysis logic, defines a logically partitioned computing environment for attribution state management. From a systems design perspective, this improves overall modularity, auditability, and security of machine learning infrastructure by externalizing semantic watermarking data from the volatile and dynamic runtime environment in which models are deployed. Such separation also facilitates federation, allowing the attribution subsystem to support multiple models, model variants, or enterprise clients from a common reference base, without requiring attribution logic to be embedded directly into each deployed container. Moreover, by preserving embeddings and centroids in a form that is queryable, reproducible, and computationally detached from the deployed model weights, manager system 110 ensures that attribution remains transparent, explainable, and cryptographically attestable—a distinct computing function that can persist even if the model hosting infrastructure is re-deployed, replaced, or reconfigured.

Accordingly, the combination of manager system 110 and data repository 108 defines not only a data persistence layer, but a technical watermark storage subsystem that forms a distinct computing environment responsible for the generation, isolation, and operational integrity of attribution data structures. This architectural separation enhances the performance, maintainability, and reliability of model attribution operations, and enables a novel form of model governance wherein attribution metadata is preserved, secured, and applied from outside the inference runtime—providing systemic improvements to the design, operation, and security of large-scale machine learning deployments.

Embodiments herein recognize that documents produced via unauthorized use of a deployed model can be hosted on content management servers of content management servers 150A-150Z. Content management servers 150A-150Z can be servers of content distributors. Content management servers that store text and image documents for public access can be designed with features that support accessibility, scalability, security, and performance. These servers can provide structured storage systems that organize documents into logical collections, enabling efficient retrieval through metadata tagging, indexing, and search functionality. They can support a wide range of file formats, including PDFs, DOCX files, plain text, and common image formats such as JPEG and PNG. Access controls can be implemented to manage permissions, allowing documents to be publicly accessible while still offering administrative features for upload, versioning, or moderation. Content delivery can be optimized using caching, content distribution networks (CDNs), and load balancing to ensure fast, reliable access for users across geographic regions. The server interface can be accessible through web-based portals, APIs, or custom applications, providing flexible integration with other systems. These servers can also support logging and analytics tools to track document access, user behavior, and system performance over time. To ensure sustainability and integrity, content management servers can include backup and recovery features, as well as support for data integrity validation. Overall, such servers can function as the backbone for digital libraries, public repositories, or documentation hubs across various domains.

At update block 1109, manager system 110 can update an evolving list of content management servers from content management servers 150A-150Z to check for unauthorized use of a deployed model from models area 2122. In one use case, the evolving list can include a predetermined list of content management servers. In another aspect, the evolving list can be adapted based on reporting data sent from UE devices 140A-140Z at 1401.

UE devices of UE devices 140A-140Z can include individual users of system 100. Manager system 110 can make available a portal for reporting suspected unauthorized use of a model from models area 2123. The reporting data sent at block 1401 can include reporting data reported via use of such portal. In another aspect, reporting data sent at send block 1401 can include a document suspected of being created via unauthorized use of a model from models area 2122. On completion of update block 1109, manager system 110 can proceed to send block 1110.

At send block 1110, manager system 110 can send document request data for receipt by content management servers from content management servers 150A-150Z. On receipt of the document request data, content management servers from content management servers 150A-150Z can proceed to send block 1501.

At send block 1501, in response to receipt of the document request data sent at block 1109, content management servers from content management servers 150A-150Z can send document data for receipt by manager system 110. Document data sent at block 1501 can include document data to be subject to checking for unauthorized use with respect to one or more trained model from models area 2122.

On receipt of the document data sent at block 1501, manager system 110 can proceed to criterion block 1111. At criterion block 1111, manager system 110 can determine whether one or more predictive models have been qualified for attribution checking with respect to the received document data. Upon satisfying this criterion, manager system 110 can proceed to embedding block 1112.

At embedding block 1112, manager system 110 can perform embedding on one or more candidate documents in order to generate semantic vector representations suitable for downstream attribution analysis. Candidate documents can include content acquired from external sources, content management systems, user reports, or through automated ingestion routines. The purpose of the embedding process is to convert each candidate document into one or more high-dimensional vectors that numerically represent the semantic structure of the document.

To perform this embedding, manager system 110 can apply a transformer-based language model such as BERT™, GPT®, ROBERTa™, or Sentence-BERT™. The embedding model used for candidate documents can be the same as that applied during training data processing, ensuring compatibility and alignment in vector space. Candidate documents may optionally be preprocessed—e.g., through tokenization, normalization, or lemmatization-prior to embedding, depending on the configuration of the manager system.

For each candidate document, manager system 110 can generate either a single embedding vector or multiple embedding vectors. In one use case, a single vector can be derived using techniques such as mean pooling, max pooling, or selection of a pooled token (e.g., the [CLS] token in BERT™). This can be appropriate for short or thematically cohesive documents.

In another use case, manager system 110 can generate multiple embeddings per candidate document—for example, at the sentence, paragraph, or token-group level—to preserve finer semantic distinctions. This multi-vector representation can support more detailed attribution analysis, particularly when documents include topic transitions or structurally distinct sections.

The output of embedding block 1112 is thus a set of one or more semantic vectors corresponding to one or more candidate documents. These vectors can be used in one of two ways: (i) they can be directly compared to known watermark centroids if only a single vector is present, or (ii) they can be subjected to clustering when multiple vectors are produced across a document batch. The embeddings produced at block 1112 retain structural parity with those generated from training data, enabling direct attribution analysis in vector space.

Upon completion of embedding at block 1112, manager system 110 can proceed to clustering block 1113. However, clustering may or may not be performed depending on the number and type of embeddings generated.

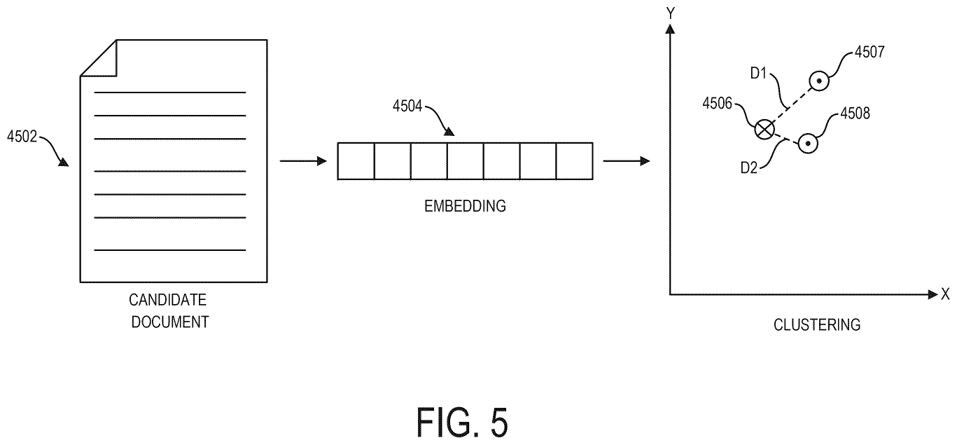

As illustrated in FIG. 5, in the special case where embedding is performed on a single candidate document, and the result is a single vector, manager system 110 can bypass clustering entirely. In this use case, the single output vector can be directly projected into semantic space and compared against known training data centroids for attribution purposes. No clustering step is required because there is only one semantic point of reference.

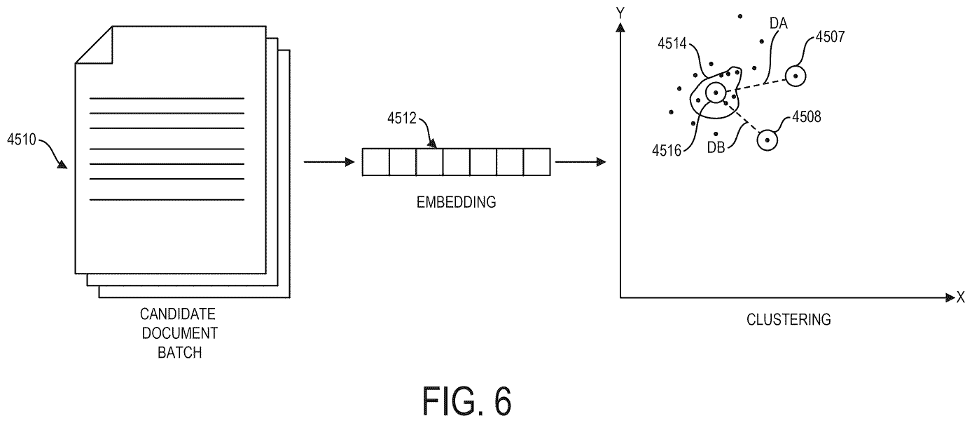

By contrast, as illustrated in FIG. 6, when manager system 110 processes a batch of candidate documents, or when multiple embeddings are generated per document, clustering can be applied to organize the resulting vectors into semantically coherent groups. At clustering block 1113, manager system 110 can perform clustering on these embeddings to derive one or more centroids summarizing the batch.

To begin clustering, manager system 110 can receive as input the full set of embeddings generated at block 1112. Each embedding vector corresponds to a point in high-dimensional semantic space.

Manager system 110 can then apply a clustering algorithm, such as K-means, DBSCAN, or hierarchical clustering, to group semantically similar vectors. K-means can be used when a fixed or estimated number of clusters is desired, with K determined using methods such as the elbow heuristic. DBSCAN can be used when clusters of arbitrary shape and density are expected, or when the number of clusters is not known in advance.

In some embodiments, manager system 110 can increase robustness by performing clustering multiple times across partitioned subsets of the data. For instance, k-fold clustering may be applied, where the vector set is split and clustered across k folds, and centroids are averaged across runs to produce stable reference positions. This process can also generate statistical information—such as standard deviation vectors—for defining distance thresholds in attribution.

The output of clustering block 1113 is one or more centroids, each representing the semantic center of a group of candidate document embeddings. These centroids can be used for direct comparison against the watermark centroids derived from training data.

The number of centroids output by manager system 110 can vary depending on the structure of the input. A single centroid may be produced when embeddings are semantically uniform or derived from a small, focused batch. Multiple centroids may be produced when candidate content includes diverse topics or writing styles, allowing manager system 110 to preserve semantic substructure during attribution.

By performing clustering in this way, manager system 110 transforms complex, unstructured candidate inputs into a compact set of semantic signatures that can be evaluated for proximity to a known training distribution. Whether processing a single document or a broad batch, the system enables scalable, domain-aware watermark verification through flexible application of embedding and clustering logic.

Manager system 110 performing embedding at embedding block 1112 and clustering at clustering block 1113 in different use cases is further illustrated with reference to FIGS. 5 and 6.

In the use case depicted in FIG. 5, manager system 110 can perform embedding 4504 with respect to a single candidate document 2502, received via block 1401 or block 1501. In this scenario, manager system 110 generates a single semantic vector 4506 defining a centroid that is projected into vector space. Because only one candidate document is processed, clustering is not required, and the resulting embedding vector 4506 can be used directly for attribution analysis.

By contrast, in the use case illustrated in FIG. 6, document data received at block 1401 and/or block 1501 can include a batch of candidate documents. In this case, manager system 110 can perform embedding 4512 to generate multiple embedding vectors—one per document—each of which is projected into semantic vector space as shown in the clustering diagram of FIG. 6.

At clustering block 1113, manager system 110 can apply a clustering algorithm to the batch of candidate document embeddings and identify one or more clusters, such as cluster 4514. The system can then compute a centroid 4516 for that cluster. This centroid represents the semantic fingerprint of the evaluated batch and serves as the candidate-side attribution input for comparison against known training data centroids.

Upon completing clustering at block 1113, manager system 110 can proceed to comparing block 1114. At this stage, manager system 110 compares the results from candidate-side embedding and clustering (or direct embedding, in the case of a single document) to reference centroids derived from training data at clustering block 1107.

At comparing block 1114, manager system 110 determines a distance between each candidate document embedding or candidate-side centroid and one or more watermark centroids associated with trained models. In the single document use case of FIG. 5, manager system 110 compares embedding vector 4506 directly to one or more watermark centroids, such as centroid 4507 and centroid 4508, which correspond to first and second models stored in models area 2122.

In this case, manager system 110 can calculate distance values D1 and D2—where D1 is the distance between candidate vector 4506 and watermark centroid 4507, and D2 is the distance between vector 4506 and centroid 4508.

In the batch use case shown in FIG. 6, manager system 110 compares centroid 4514—generated from the batch of candidate documents—to watermark centroids 4507 and 4508. In this scenario, distance values such as DA and DB can be computed to determine the similarity between the batch and known model fingerprints.

Upon completing the comparison, manager system 110 proceeds to action decision block 1115. At this stage, the system determines whether the candidate-side vectors or centroids fall within a threshold distance of one or more watermark centroids.

If a computed distance-such as D1, D2, D_A, or D_B—falls below a predefined similarity threshold, manager system 110 can infer that the candidate document or batch was likely generated using a model represented by the corresponding watermark centroid. If the associated model is not authorized for use in the evaluated context, manager system 110 can proceed to initiate remediation procedures.

At embedding block 1112, manager system 110 can be configured to perform natural language processing (NLP)-based embedding of one or more candidate documents, using the same or a compatible embedding model as used at embedding block 1106 for the training data. Manager system 110 can apply a transformer-based language model (e.g., BERT™, ROBERTa™, or Sentence-BERT™) to generate semantic embedding vectors that numerically represent the meaning of each candidate document.

When a candidate document yields a single embedding vector, manager system 110 can directly designate that vector as a candidate-side centroid. As used herein, a centroid can refer either to (i) a vector calculated as the statistical center of a cluster of embeddings, or (ii) a single embedding vector representing a document, in cases where clustering is not applied. In both cases, the term “centroid” refers to a vector that serves as a semantic reference point for attribution comparison in vector space. Thus, in single-document workflows where no clustering occurs, the embedding vector itself is the centroid.

In other scenarios, such as when a candidate input includes multiple documents or structurally segmented content (e.g., paragraphs or sections), manager system 110 can generate multiple embedding vectors and proceed to clustering block 1113. At this block, manager system 110 can apply a clustering algorithm (e.g., K-means or DBSCAN) to group semantically similar embeddings and compute one or more statistical centroids representing the center of each identified cluster. Whether derived through clustering or assigned based on single-document embedding, each candidate-side centroid defines a semantic position in vector space for attribution analysis.

At comparing block 1114, manager system 110 can compute the semantic distance between one or more candidate-side centroids and the training-side centroids generated at clustering block 1107. A variety of comparison strategies can be used depending on the number and type of centroids involved.

In the simplest case, both the training data and candidate document are represented by a single centroid, and manager system 110 can compute a Euclidean distance as follows:

Distance=∥C_train−C_cand∥₂ (Eq. 1)

Here, C_train is the centroid computed from the training data, and C_cand is the centroid representing the candidate document-whether computed through clustering or directly assigned. Attribution can be determined using a threshold T:

Attributed if ∥C_train−C_cand∥₂∥≤T (Eq. 2)

In cases where the training data is represented by multiple centroids (C₁, C₂, . . . , C_m), and the candidate content is represented by a single centroid, manager system 110 can compute a set of distances:

Distance_j=∥C_cand−C_j∥₂, for j=1 to m (Eq. 3)

The minimum among these distances can be used to evaluate attribution:

MinDistance=min(∥C_cand−C_j∥₂), for j=1 to m (Eq. 4)

If MinDistance is within a predefined threshold T, the candidate document can be attributed to the model associated with the nearest training-side centroid.

In use cases where both the candidate data and the training data are represented by multiple centroids, manager system 110 can compute an n×m distance matrix, where each candidate-side centroid D_i is compared against each training-side centroid C_j:

Distance_{i,j}=∥D_i−C_j∥₂, for i=1 to n and j=1 to m (Eq. 5)

From this, manager system 110 can compute the minimum distance across all centroid pairs:

MinDistance=min(∥D_i−C_j∥₂) for all i,j (Eq. 6)

Alternatively, manager system 110 can compute the average of minimum distances from each candidate-side centroid to its nearest training-side centroid:

AvgMinDistance=(1/n)×Σ_{i=1 to n} min(∥D_i−C_j∥₂) (Eq. 7)

Attribution can then be determined using either of the following decision rules:

Attributed if MinDistance≤T (Eq. 8)

Attributed if AvgMinDistance≤T (Eq. 9)

This unified centroid-based comparison framework allows manager system 110 to operate seamlessly across both single-document and multi-document scenarios, using a consistent semantic representation. By defining centroid to include both clustered and direct embeddings, the system supports precise, scalable, and legally defensible attribution workflows for detecting unauthorized model usage.

In one embodiment, manager system 110 can render an action decision to trigger remediation upon detecting that a candidate document 4502 (as in FIG. 5) or a candidate document batch 4510 (as in FIG. 6) was likely generated using a model from models area 2122 without authorization. Such remediation may include issuing alerts, initiating access controls, or logging attribution for audit purposes.

On completion of action decision block 1115, manager system 110 can proceed to send block 1116. At send block 1116, manager system 110 can send notification data to appropriate enterprises associated with the one or more documents identified as being produced through unauthorized use of an LLM. Notification data sent at block 1115 can be received by one or more API service endpoint of at least one enterprise system of enterprise systems 170A-170Z. In one embodiment the sent notification data can define control data for control of a process. In one embodiment the sent notification data can define visualization data for visualization of a detected attribution, e.g., on a user interface. On completion of send block 1116, manager system 110 can proceed to send block 1117. At send block 1117, manager system 110 can send command data. Command data sent at block 1117 can include command data to perform a remediation with respect to the identified unauthorized use of a model from models area 2122.

On receipt of the command data sent at block 1117, model hosting servers 160A-160Z can perform action at action block 1602 in accordance with the received command data sent at send block 1117. When it is determined that a certain machine learning model, such as a large language model (LLM), hosted on a particular model hosting server has been subject to unauthorized use in connection with the creation of one or more documents, a range of remediation actions can be taken to secure the environment, mitigate the impact, and prevent future incidents.

First, the model hosting server can be reconfigured to tighten access controls and limit exposure. This can include updating authentication mechanisms (e.g., rotating API keys or enforcing multi-factor authentication), redefining role-based access permissions, and revoking access credentials associated with unauthorized actors. Endpoint-level access can be restricted or disabled altogether while further investigation is conducted.

The hosting server can also be subjected to a comprehensive security audit to review system logs, model invocation records, and user access patterns to determine the scope of the unauthorized activity and assess whether any other systems or models may have been compromised. In cases where server integrity or trust has been degraded, the model itself can be rehosted in a more secure or isolated environment. Rehosting the model can involve deploying it to a new instance or infrastructure, potentially within a private cloud, isolated container, or air-gapped virtual network.

This new hosting configuration can incorporate enhanced logging, usage rate-limiting, encryption (both at rest and in transit), and monitoring solutions to detect anomalous behavior in real time. The model may also be reconfigured as part of the remediation effort-such as by applying updated filters to prevent misuse, constraining prompt types, or introducing behavioral guardrails via fine-tuning or prompt templates designed to limit certain outputs.

Additionally, the organization may implement policy-driven controls such as requiring human-in-the-loop review for high-risk use cases, imposing token usage ceilings, or requiring usage justification metadata at runtime. Any documents suspected to have been generated through unauthorized access can be flagged, quarantined, or submitted for administrative review. Automatic content tracking tools can be deployed to scan new or existing documents for signatures indicative of unauthorized model use.

If the model was part of an externally facing API or multi-tenant deployment, client segmentation and credential rotation may be performed to contain the breach. Legal or compliance teams may be involved to evaluate the need for breach notification under regulatory obligations. Forward-looking remediation can also include implementing anomaly detection algorithms that alert administrators when usage patterns deviate from historical baselines, helping to ensure that future unauthorized behavior is caught early.

Together, these remediation actions can restore trust in the model hosting environment, safeguard sensitive model assets, and reduce the risk of future misuse. By combining technical, administrative, and policy-driven countermeasures, embodiments can support resilient model deployment infrastructures even in the presence of evolving security and governance challenges.

At block 1114, manager system 110 can be configured to evaluate a semantic distance metric calculated at comparing block 1114 and determine whether the similarity between a candidate document and the semantic fingerprint (centroids) of a known model justifies attribution. The calculated distance—whether derived from a single centroid comparison (e.g., Eq. 1 or Eq. 4), an average minimum distance across clusters (e.g., Eq. 7), or a distance matrix (e.g., Eq. 5)—serves as a quantitative indicator of likely unauthorized model use. A lower distance indicates stronger semantic alignment and therefore a higher probability that the content was generated using the monitored model.

Manager system 110 can interpret this similarity score across graduated confidence zones, enabling tiered action decisions that range from passive monitoring to full-scale model rehosting. Each tier may trigger a different remediation protocol at block 1116, where manager system 110 can issue command data to one or more model hosting servers 160A-160Z. These servers can include containerized deployment platforms capable of runtime orchestration (e.g., Kubernetes®), access control (e.g., via OAuth2 or API key registries), secure data handling (e.g., encrypted storage, firewalled subnets), and compliance-layer monitoring (e.g., token usage tracking, audit trails, anomaly detection).

Importantly, remediation actions can be cumulative, meaning that closer matches may trigger all the actions associated with higher-distance zones, plus additional containment or security responses. For example, a critical match (e.g., distance≤0.20) may result in full rehosting of the model into a hardened environment, while also rotating keys, restricting access, and issuing compliance notifications that were previously initiated at higher-distance thresholds.

The scaled remediation logic employed by manager system 110 is illustrated in Decision Table A below. This table organizes action decision tiers based on distance ranges and confidence levels, and maps those to explicit behavior by manager system 110 and the model hosting infrastructure.

TABLE A

| | Distance and | Actions Performed by Manager System 110 (Including |
|---|---|---|
| Row | confidence | Commands to Model Hosting Servers) |
| 1 | >0.85 | No attribution logic triggered. Manager system 110 records the |
| | (Negligible) | event as a background semantic divergence datapoint. Event is |
| | | archived in a low-priority telemetry log. No alerts, no tagging, no |
| | | downstream processing. Content is not flagged and is excluded |
| | | from attribution queues. Model hosting servers are not pinged. |
| | | This threshold supports baselining and variance drift tracking |
| | | across long-term deployments. |
| 2 | 0.70-0.85 | Manager system 110 performs passive semantic correlation |
| | (Low | analysis. Updates real-time heat maps and centroid tracking |
| | Confidence) | analytics. Sends passive “match-class-low” tag to internal session |
| | | monitoring database. Triggers zero infrastructure response but |
| | | adds record to attribution telemetry for future comparison. If |
| | | match frequency from same source increases, a cumulative risk |
| | | score may be elevated later. Model hosting servers receive no |
| | | configuration updates. System remains in full operational state. |
| 3 | 0.55-0.70 | Attribution confidence surpasses passive threshold. Manager |
| | (Moderate) | system 110 creates attribution candidate profile tied to the |
| | | document ID, user agent string, IP, and request signature hash. |
| | | Automatically flags document in internal CMS for asynchronous |
| | | NLP-based review. Sends command to model hosting servers to |
| | | retain full prompt logs and associate event with long-term audit |
| | | trail. Usage metadata including token count, response length, and |
| | | generation latency are timestamped and archived. Triggers no |
| | | access restriction but moves origin to “watch” status under an |
| | | enterprise trust model. |
| 4 | 0.40-0.55 | Attribution event escalated. Manager system 110 |
| | (Elevated) | generates structured risk vector incorporating centroid |
| | | proximity, prompt class, frequency of prior matches, and |
| | | temporal density of requests. Sends active remediation |
| | | directive to model hosting servers to begin intermediate |
| | | containment: |
| | | Throttle token generation rate and maximum output length; |
| | | Attach semantic watermarking to new responses; |
| | | Force all requests from origin to low-priority compute |
| | | queues. |
| | | Server-side API gateway settings are modified to enforce |
| | | stricter rate limits, and container logging is raised to |
| | | DEBUG level with automatic offload to secured log store. |
| 5 | 0.25-0.40 | Manager system 110 asserts provisional attribution to a |
| | (High) | monitored model. Triggers organizational alert flow: |
| | | Internal security (SOC), enterprise risk officers, and |
| | | compliance teams are notified; |
| | | Document and session metadata exported to incident |
| | | staging area. |
| | | Sends command to hosting servers to: |
| | | Rotate API keys; |
| | | Force invalidate bearer tokens; |
| | | Re-encrypt session storage; |
| | | Restart model container with restricted container profile |
| | | (locked-down runtime profile) (no external DNS, locked |
| | | port range, locked port-level controls). |
| | | Prompts from matching users may now require just-in- |
| | | time review approval. In-app user interfaces may be |
| | | temporarily disabled and dynamic content filters may |
| | | apply. |
| 6 | | Manager system 110 classifies document as definitively |
| | | attributed to a protected model. Triggers full-spectrum |
| | | remediation: |
| | | Automatically seals audit trail for legal evidentiary use; |
| | | Sends cease and desist alert to external endpoint, if IP |
| | | reverse-resolvable; |
| | | Generates internal forensic report with vector match ID, |
| | | clustering confidence, and k-fold deviation spread. |
| | | Commands hosting servers to execute comprehensive |
| | | lockdown: |
| | | Rehost model into hardened VPC with end-to-end TLS, |
| | | no external ingress, and geofence enforcement; |
| | | Apply anomaly detection engine to all runtime I/O; |
| | | Enable fine-grained prompt tracing with NLP |
| | | classification and AI output scoring; |
| | | Inject behavior rules to deny or redirect sensitive |
| | | generations; |
| | | Enforce MFA for all user access tokens going forward. |
| | | Previous endpoint added to denylist across enterprise |
| | | threat graph. All future semantic proximity events within |
| | | threshold from this origin will trigger immediate pre- |
| | | emptive shutdown. |

The thresholds defined in Decision Table A (e.g., >0.75, ≤0.20) can be tuned based on empirical testing, receiver operating characteristic (ROC) analysis, or adaptive feedback from human reviewers. In production, manager system 110 can calibrate these thresholds based on the variance statistics generated during k-fold clustering of training data and model outputs, ensuring that confidence intervals remain statistically meaningful across different deployment scenarios.

Command data issued by manager system 110 at send block 1117 can include REST API calls, YAML files for Kubernetes® pod reconfiguration, or direct orchestration commands to underlying cloud infrastructure. These commands can invoke changes in the security posture, resource allocation, or access control structure of the affected model instance. Model hosting servers 160A-160Z can be pre-provisioned with APIs or policy engines that expose these capabilities, allowing manager system 110 to initiate remediations with minimal latency and operational overhead.

Each hosting server may be instrumented to support real-time detection and logging of remediation triggers, including the ability to log every prompt, truncate response lengths, escalate to multi-factor authentication, or require human-in-the-loop validation before high-confidence prompts are processed.

In particularly sensitive deployments—such as healthcare, finance, or regulated government contexts—hosting servers may be configured to air-gap the model and disconnect external endpoints entirely until manual review and revalidation occur. In this configuration, manager system 110 not only initiates automated containment but also enters a post-remediation monitoring state, checking for repeated proximity matches or re-attempted unauthorized access from previously flagged endpoints.

Together, blocks 1115 and 1116 empower manager system 110 with a robust, data-driven, and infrastructure-aware framework for monitoring, attributing, and controlling unauthorized model usage—backed by tiered remediation procedures that scale proportionally with semantic similarity.

Referring to Row 5, in response to a confirmed or high-confidence attribution event, manager system 110 can perform targeted session and access remediation by issuing structured command data to model hosting servers 160A-160Z. These commands can instruct the servers to rotate all API keys associated with the affected model instance, thereby revoking any previously issued credentials and preventing continued unauthorized access. Concurrently, manager system 110 can issue a directive to force invalidate all active bearer tokens tied to the model's access endpoints, ensuring immediate termination of in-progress sessions. To further secure in-flight data, manager system 110 can command re-encryption of session storage, including temporary caches, logs, or token archives, using newly provisioned encryption keys provisioned as part of the remediation process. Finally, manager system 110 can instruct the hosting infrastructure to restart the model container using a hardened or restricted container profile, which may be defined in advance by a security policy manifest. This restricted profile can include disabling external DNS resolution, locking down ingress and egress port ranges, and limiting runtime privileges to only those required for internal service calls. These commands may be issued via a secure orchestration interface (e.g., Kubernetes®, Docker API, or cloud-native deployment tool) and can be accompanied by post-remediation verification steps such as health checks, policy validation, and audit logging to confirm that the model environment has been resecured.

Referring to Row 6, upon detection of unauthorized or high-risk model usage, manager system 110 can initiate a secure rehosting operation by transmitting command data to one or more model hosting servers 160A-160Z, instructing that the affected model be redeployed into a hardened virtual private cloud (VPC) environment. This command data can specify that the new hosting instance enforce end-to-end TLS encryption, disable all external ingress points, and apply geofence restrictions to allow only traffic originating from approved geographic regions or internal subnets. To enforce these conditions, manager system 110 may transmit infrastructure-as-code directives (e.g., Kubernetes® manifests or cloud orchestration templates) that define a secure container profile, restrict external DNS exposure, apply firewall or zero-trust networking rules, and invoke service mesh configurations to ensure encrypted, authenticated communication. As part of the rehosting workflow, manager system 110 can revoke existing access tokens, terminate active sessions, and migrate the model—along with its audit trail and attribution logs—into the secure zone. After rehosting, manager system 110 can verify deployment integrity by confirming TLS enforcement, network isolation, regional compliance, and operational health, ensuring that the rehosted model is fully contained, access-controlled, and shielded from further unauthorized activity.

There is set forth herein, according to one embodiment embedding training documents used to train the machine learning model to generate training embeddings; clustering the training embeddings to generate one or more reference centroids, wherein respective ones of the reference centroids represent clusters of semantically similar training embeddings; deploying the machine learning model to a model hosting server configured to serve model inference requests; embedding candidate document data to generate one or more candidate embeddings; comparing the one or more candidate embeddings to the one or more reference centroids using a vector space distance metric; and presenting an indication that the candidate document data is attributable to the machine learning model based on a result of the comparing. Presenting an indication herein can include, e.g., issuing notification data or command data at send block 1116 and/or send block 1117, which can include, e.g., dispatching an internal flag to a session monitoring system, transmitting structured API commands to model hosting servers, recording attribution events into an audit log, triggering escalation to a security operations center (SOC), or sending orchestration instructions to rehost a model into a hardened environment. Presenting an indication can further encompass structured messaging workflows like updating attribution metadata, tagging user sessions with match-class indicators, transmitting compliance alerts to enterprise risk systems, or signaling containerized hosting platforms to rotate keys, invalidate bearer tokens, or restrict DNS resolution. Thus, presenting an indication broadly includes both direct user-facing alerts and/or indirect machine-level or infrastructure-level communications that function to manifest attribution determinations in a systemically actionable way. Presenting an indication can also or alternatively include UI visualizations, such as displaying a risk score, attribution confidence meter, warning banners in an administrator dashboard, real-time event listings in a monitoring console, or visual risk classification overlays, thereby informing human operators of attribution determinations in a tangible and actionable form. Thus, presenting an indication broadly includes both direct user-facing alerts and indirect machine-level or infrastructure-level communications that function to manifest attribution determinations in a systemically actionable way.

Embodiments herein recognize that presenting an indication can also or alternatively include presenting a positive notification that candidate document data is not attributable to the machine learning model. For example, where the comparison between the candidate embeddings and the reference centroids results in a determination of non-attribution, the presenting can include issuing a positive confirmation, such as updating a monitoring system to reflect a non-infringing status, sending a notification to an enterprise system that no unauthorized use has been detected, or presenting a reassuring visualization in an administrative dashboard confirming attribution clearance. In some embodiments, the system may initiate positive remediation actions in response to the non-attribution determination, such as automatically rehosting the model into a standard, cost-optimized cloud environment, migrating the model back to a general access hosting platform, or downgrading enhanced monitoring policies previously in place. For instance, upon confirming that a candidate batch is not attributable, manager system 110 could transmit command data to relax compute throttling constraints, revert security profiles to baseline operational configurations, or terminate elevated audit logging states that had been temporarily enabled during attribution assessment. Thus, presenting an indication encompasses not only adverse determinations but also positive clearance events, optionally coupled to beneficial system state transitions. Presenting an indication herein can include, in some embodiments, presentation of results via output elements of a computer system, such as a message displayed on a display screen, an audio notification played through a speaker, or another output device (e.g., LED indicators, haptic feedback). For example, the manager system 110 may perform a distance analysis and present an indication that a first suspect document likely originated from the model, while a second suspect document likely did not, via display outputs or system messaging. In some embodiments, a positive remediation action may be initiated following a non-attribution result, such as relaxing monitoring controls, migrating the model back to a standard hosting environment, terminating elevated audit logging, or executing a cost optimization redeployment. Thus, presenting an indication can encompass both adverse and positive attribution determinations, optionally coupled with proactive system management responses.

On completion of send block 1117, manager system 110 can proceed to return block 1118. Manager system 110 can also proceed to return block upon return of a “no” result from performance of criterion block 1111. At return block 1118, manager system 110 can return to the stage preceding block 1101. Manager system 110 can be iteratively performing the loop of blocks 1101-1118 during a deployment period of manager system 110.

On completion of send block 1701, enterprise systems 170A-170Z proceed to return block 1702. At return block 1702, enterprise systems 170A-170Z can return to the stage preceding send block 1701. Enterprise systems 170A-170Z can be iteratively performing the loop of blocks 1701-1702 during the deployment period of enterprise systems 170A-170Z.

On completion of send block 1501, content management servers 150A-150Z can proceed to return block 1502. At return block 1502, content management servers 150A-150Z can return to a stage preceding block 1501. Content management servers 150A-150Z can iteratively perform the loop of blocks 1501-1502 during a deployment period of content management servers 150A-150Z.

On completion of action block 1602, model hosting servers 160A-160Z can proceed to return block 1603. At return block 1603, model hosting servers 160A-160Z can return to the stage preceding deployment block 1601. Model hosting servers 160A-160Z can be iteratively performing the loop of blocks 1601-1603 during a deployment period of model hosting servers 160A-160Z.

UE devices 140A-140Z, on completion of send block 1401, can proceed to return block 1402. At return block 1402, UE devices 140A-140Z can return to the stage preceding send block 1401. UE devices 140A-140Z can be iteratively performing the loop of blocks 1401-1402 during the deployment period of UE devices 140A-140Z.

The explosion of private and public Large Language Models (LLMs) has promised substantial productivity gains but has also raised worries around how they could be used to generate disinformation (either willingly by malicious actors or by “hallucinating”), help students cheat in teaching environments, or be trained on proprietary data, among other issues. As such, being able to transparently identify which LLM generated a given piece of text can be invaluable in combating the aforementioned harms. However, identifying LLMs is not an easy task. Much of the research centers around a priori modification of LLMs by changing the distributions of terms generated by an LLM or by introducing rare words that could then be linked to an LLM.

Embodiments herein allow the identification of an LLM a posteriori by embedding and clustering the training data used to build the LLM and calculating the centroids. Embodiments herein can identify LLM-generated text by embedding and clustering it as well, and calculating the difference between its centroids and the LLM's own: if centroids are very close (or far) to one another, then there is a strong (or weak) probability the text comes from the given LLM. Embodiments herein permit an LLM provider to track where and how its LLMs are being used, and provide for remediation of unauthorized use.

LLMs can be increasingly adopted as solutions for a wide range of natural language processing tasks across diverse domains. However, ensuring that a privately trained LLM is not being accessed or used outside of its intended user base can be challenging, particularly because generated outputs can be difficult to trace back to the originating model. In many cases, it can be nearly impossible to determine which LLM produced a given piece of text without embedded identifiers. This is where watermarking techniques can be useful. Conventional watermarking methods for LLMs can involve modifying outputs by embedding detectable patterns or tokens that signal the origin of the content. However, embodiments herein can offer a watermarking solution that does not alter the LLM or its output in any way. Instead, the approach can rely on computing meta-information from the training data and model outputs to create a unique, statistical fingerprint of the LLM.

In embodiments herein, training data and outputs from the target LLM can be used to generate cluster centroids using an embedding and clustering process. These centroids can reflect the semantic distribution associated with the specific model and serve as a reference fingerprint. The distance between centroids derived from the training data and those derived from model outputs can be measured to characterize the LLM's unique signature. Access to the training data and its derived centroids can be limited to the original model trainer, ensuring that only authorized users can compute and verify this distance.

When evaluating whether an unknown LLM has produced a given output, sample text can be passed through the same embedding and clustering process to generate new centroids. The resulting centroid set can then be compared to the original reference centroids, and a similarity distance can be calculated. If the distance exceeds a predefined threshold, the output can be considered inconsistent with the reference model. If the distance falls within the expected range, the output can be attributed to the original, private LLM with high confidence. This approach can provide a non-invasive, model-agnostic method for attributing generated content using semantic vector distribution analysis. Additional techniques, such as multilayer embedding comparisons or confidence-based scoring systems, can be incorporated to increase attribution robustness in varied deployment environments.

Manager system 110 can be configured to implement a watermark verification process for determining whether the output of a given LLM is consistent with a known, privately trained model. This process can begin by calculating embeddings from two sources: the training data originally used to train the LLM, and a set of outputs generated by that same LLM. For the training data, embeddings can be calculated across the full dataset whenever feasible; however, in cases where computational limitations exist, manager system 110 can alternatively operate on a pre-processed version of the training data, where techniques such as lemmatization and tokenization have been applied to reduce text complexity and size. Once embeddings have been derived, manager system 110 can perform clustering-such as via K-means or DBSCAN-on the embedding vectors to generate cluster centroids. To ensure stability and reduce variance in centroid estimates, the system can apply a k-fold clustering approach (e.g., repeating the clustering process 10 times) and average the resulting centroid coordinates. When using K-means, manager system 110 can select the appropriate number of clusters using a heuristic such as the elbow method. The system can also compute the standard deviation of centroid positions across the k-fold iterations to support later thresholding operations.

The same steps can be repeated by manager system 110 for the output generated by the target LLM—calculating embeddings, performing clustering, applying k-fold averaging, and capturing standard deviation data. Once centroids are established for both the training data and the LLM output, manager system 110 can calculate the n-dimensional distance between the two centroid sets using a distance formula such as Euclidean distance across all embedding dimensions (x, y, z, . . . , n), factoring in the standard deviation range derived from the k-fold clustering results.

In cases where manager system 110 receives output from an unknown LLM, manager system 110 can also compute embeddings on this new dataset and apply the same clustering and k-fold averaging techniques to generate centroids. Manager system 110 can then calculate the distance between the centroids from the unknown LLM output and the original training data centroids. If this distance falls within the expected range—i.e., it is smaller than the threshold established by the standard deviation of the previously calculated distances—then manager system 110 can infer that the unknown output is likely to have originated from the known, private LLM. Conversely, if the distance exceeds the expected range, it can be determined that the output does not match the known LLM signature.

Several assumptions can underlie this process. First, manager system 110 assumes access to the training data originally used to build the target LLM. Second, the same embedding model should be used across training, known output, and unknown output data to ensure vector compatibility. Manager system 110 can also rely on the effectiveness of K-means clustering even when operating at large scale. Prompts used to generate output during testing can be curated based on domain-specific questions, and results may be more reliable when outputs across compared datasets are generated from common or standardized prompts. When asked why centroid distance is used, manager system 110 can interpret it as a similarity index—capturing how closely two sets of outputs align in high-dimensional semantic space—thereby offering a statistical, non-intrusive method for determining model provenance.

There is set forth herein (a) a computer-implemented method comprising embedding training documents used to train a machine learning model to generate training embeddings; clustering the training embeddings to generate one or more reference centroids, wherein respective ones of the reference centroids represent clusters of semantically similar training embeddings; deploying the machine learning model to a model hosting server configured to serve model inference requests; embedding candidate document data to generate one or more candidate embeddings; comparing the one or more candidate embeddings to the one or more reference centroids using a vector space distance metric; and presenting an indication that the candidate document data is attributable to the machine learning model based on a result of the comparing. There is also set forth herein (b) the computer-implemented method of (a), wherein the deploying the machine learning model to the model hosting server is performed prior to the clustering of the training embeddings. There is also set forth herein (c) the computer-implemented method of (a), further comprising transmitting the one or more reference centroids to a secure watermark storage subsystem for storage. There is also set forth herein (d) the computer-implemented method of (a), further comprising transmitting the one or more reference centroids to a secure watermark storage subsystem. There is also set forth herein (e) the computer-implemented method of (a), wherein the embedding and clustering comprise generating a respective reference centroid for each training document in the training documents, such that the one or more reference centroids collectively define a fine-grained attribution signature representing document-level semantic structure of a training dataset defined by the training documents, enabling document-level attribution precision. There is also set forth herein (f) the computer-implemented method of (a), wherein the clustering comprises grouping the training embeddings into multiple clusters, each corresponding to a semantically coherent subgroup of a training dataset defined by the training documents, and generating a respective reference centroid for each cluster, thereby forming a multi-centroid attribution profile that captures distinct subject matter domains or writing styles within the training dataset and enables domain-aware attribution. There is also set forth herein (g) the computer-implemented method of (a), wherein the candidate document data comprises a single candidate document, and the determining comprises comparing a vector embedding of the single candidate document to one or more of the reference centroids using the vector space distance metric to determine that the candidate document was generated by the machine learning model. There is also set forth herein (h) the computer-implemented method of (a), wherein the candidate document data comprises a batch of two or more candidate documents, and the determining comprises generating candidate embeddings for the batch, performing clustering on the candidate embeddings to generate a batch centroid, and comparing the batch centroid to the one or more reference centroids using the vector space distance metric to determine that the candidate batch was generated by the machine learning model. There is also set forth herein (i) the computer-implemented method of (a), further comprising initiating a remediation action in response to determining that the candidate document data is attributable to the machine learning model, wherein the remediation action comprises a policy-based enforcement procedure to address suspected unauthorized use of the machine learning model, the enforcement procedure being triggered based on attribution confidence determined from the result of the comparing. There is also set forth herein (j) the computer-implemented method of (a), further comprising initiating a remediation action in response to determining that the candidate document data is attributable to the machine learning model, wherein the remediation action is selected from a tiered set of enforcement responses based on a similarity score derived from the comparing between the one or more candidate embeddings and the one or more reference centroids, the tiered set of enforcement responses selected from a group consisting of: logging the attribution, notifying an enterprise system, invalidating access credentials, and redeploying the machine learning model to a hardened hosting environment with elevated security controls. There is also set forth herein (k) the computer-implemented method of (a), further comprising initiating a remediation action in response to determining that the candidate document data is attributable to the machine learning model, wherein the remediation action comprises transmitting a system notification to an enterprise control endpoint and invalidating one or more bearer tokens associated with user or application access to the machine learning model, the remediation action being triggered in response to a similarity score exceeding a predefined threshold indicative of moderate attribution confidence. There is also set forth herein (1) the computer-implemented method of (a), further comprising initiating a remediation action in response to determining that the candidate document data is attributable to the machine learning model, wherein the remediation action comprises rehosting the machine learning model to a hardened virtual private cloud environment, the hardened environment comprising end-to-end encrypted communication, restricted ingress access, enforced geofence constraints, and redeployment of the model within a locked container profile configured to disable external DNS resolution, restrict available ports, and isolate the model from multi-tenant inference workloads. There is also set forth herein (m) the computer-implemented method of (a), further comprising logging attribution metadata corresponding to the comparing between the one or more candidate embeddings and the one or more reference centroids, wherein the attribution metadata includes one or more of a timestamp, a model identifier, a similarity score, and an attribution determination outcome, and storing the attribution metadata in an audit log. There is also set forth herein (n) the computer-implemented method of (a), further comprising initiating a remediation action in response to determining that the candidate document data is attributable to the machine learning model, wherein the remediation action comprises issuing command data to a model hosting server to rotate application programming interface (API) keys associated with the machine learning model, invalidate bearer tokens tied to active sessions, re-encrypt session storage using newly provisioned encryption keys, and restart a containerized model execution environment with a restricted security profile that disables external DNS resolution, locks ingress and egress ports, and enforces runtime privilege minimization. There is also set forth herein (o) the computer-implemented method of (a), further comprising initiating a remediation action in response to determining that the candidate document data is attributable to the machine learning model, wherein the remediation action comprises rehosting the machine learning model to a hardened virtual private cloud environment, the rehosting comprising disabling external ingress, enforcing end-to-end TLS encryption, applying geographic access restrictions via geofencing, provisioning a secure container profile through infrastructure-as-code orchestration, revoking prior access tokens, migrating audit and attribution logs, and verifying that the rehosted instance of the machine learning model satisfies isolation, compliance, and operational health requirements. There is also set forth herein (p) the computer-implemented method of (a), further comprising initiating a remediation action in response to determining that the candidate document data is attributable to the machine learning model, wherein the remediation action comprises issuing command data to the model hosting server, the model hosting server comprising a containerized inference environment configured to serve model responses, the command data instructing the server to rotate API keys, invalidate bearer tokens, and restart the container in a locked-down runtime profile with restricted DNS access and port-level controls, and wherein reference centroids used for attribution are stored in a secure watermark storage subsystem comprising a computing environment logically distinct from the model hosting server. There is also set forth herein (q) the computer-implemented method of (a), further comprising initiating a remediation action in response to determining that the candidate document data is attributable to the machine learning model, wherein the remediation action comprises rehosting the machine learning model to a hardened virtual private cloud (VPC) environment and isolating the model from public access by issuing infrastructure-as-code directives that enforce end-to-end TLS, disable external ingress, apply geographic access filtering, and deploy the model into a container instance having restricted DNS resolution, reduced runtime privileges, and constrained network routing, and wherein the reference centroids are stored within a secure watermark storage subsystem comprising an attribution analysis environment external to the model hosting server, the subsystem being configured for offline clustering, policy-driven retention of attribution fingerprints, and asynchronous comparison workflows. There is also set forth herein (r) the computer-implemented method of (a), wherein the candidate document data comprises a candidate document batch of two or more candidate documents, and the clustering comprises generating a plurality of reference centroids each corresponding to a semantically distinct cluster of training embeddings, the method further comprising initiating a remediation action in response to determining that the candidate document batch is attributable to the machine learning model, the remediation action comprising executing a full-stack security lockdown across two distinct computing environments, including: rotating all API keys and invalidating bearer tokens associated with the machine learning model; re-encrypting session state, token archives, and logs using newly provisioned encryption keys; restarting a container instance of the model hosting server hosting the machine learning model within a locked-down runtime environment that disables external DNS resolution, restricts ingress and egress ports, and applies execution privilege minimization; rehosting the model to a hardened virtual private cloud infrastructure that enforces end-to-end TLS, applies geofence restrictions, and deploys the model into a container defined via infrastructure-as-code templates configured with zero-trust network segmentation, firewall constraints, and service mesh authentication; storing the reference centroids in a secure watermark storage subsystem comprising a logically distinct computing environment configured for offline clustering, attribution signature versioning, and retention of semantic fingerprint data, the subsystem being isolated from the model hosting server and implemented as a dedicated attribution layer with its own memory, processing capabilities, and internal access controls; and executing post-remediation verification processes comprising health checks, container signature validation, runtime environment integrity scans, regional compliance validation, and audit log reconciliation. There is also set forth herein(s) the computer-implemented method of (a), further comprising embedding additional candidate document data to generate one or more additional candidate embeddings, comparing the one or more additional candidate embeddings to the one or more reference centroids using a vector space distance metric, and presenting an indication that the candidate document data is not attributable to the machine learning model based on a result of the comparing.

Various available tools, libraries, and/or services can be utilized for implementation of trained predictive models herein trained by machine learning, such as predictive models of models area 2122. For example, a machine learning service can provide access to libraries and executable code for support of machine learning functions. A machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring, and retraining of deployed models. According to one possible implementation, a machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring, and retraining of deployed models. Trained predictive models herein can employ artificial neural networks (ANNs), support vector machines (SVMs), Bayesian networks, and/or other machine learning technologies.

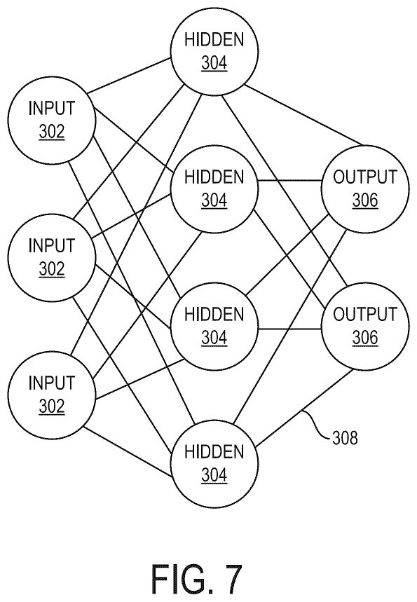

FIG. 7 is an illustration of an example ANN architecture for trained predictive models herein trained by machine learning, such as predictive models described herein.

One element of ANNs is the structure of the information processing system, which includes a large number of highly interconnected processing elements (called “neurons”) working in parallel to solve specific problems. ANNs are trained using a set of training data, with learning that involves adjustments to the weights that exist between the neurons. An ANN can be configured for a specific application, such as the applications discussed in connection with predictive models herein such as models of models area 2122.

Referring now to FIG. 7, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 302 that provide information to one or more “hidden” neurons 304. Weighted connections 308 between the input neurons 302 and hidden neurons 304 are weighted, and these weighted inputs are then processed by the hidden neurons 304 according to some function. There can be any number of layers of hidden neurons 304, as well as neurons that perform different functions. There exist different neural network structures as well, such as convolutional neural networks, maxout networks, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 306 accepts and processes weighted input from the last set of hidden neurons 304.

This represents a “feed-forward” computation, where information propagates from input neurons 302 to the output neurons 306. Upon completion of a feed-forward computation, the output is compared to a desired output available from training data. The error relative to the training data is then processed in a “backpropagation” computation, where the hidden neurons 304 and input neurons 302 receive information regarding the error propagating backward from the output neurons 306. Once the backward error propagation has been completed, weight updates are performed, with the weighted connections 308 being updated to account for the received error. It should be noted that the three modes of operation—feed-forward, backpropagation, and weight update—do not overlap with one another. This represents just one variety of ANN computation, and any appropriate form of computation may be used instead.

To train an ANN, training data can be divided into a training set and a testing set. The training data includes pairs of an input and a known output, which can be referred to as outcome training data, as referenced in connection with predictive models herein. During training, the inputs of the training set are fed into the ANN using feed-forward propagation. After each input, the output of the ANN is compared to the respective known output. Discrepancies between the output of the ANN and the known output associated with that particular input are used to generate an error value, which may be backpropagated through the ANN, after which the weight values of the ANN may be updated. This process can continue until the pairs in the training set are exhausted.

After the training has been completed, the ANN may be tested against the testing set to ensure that the training has not resulted in overfitting. If the ANN can generalize to new inputs beyond those it was trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, weights of weighted connections 308 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, weights of weighted connections 308 may be implemented as resistive processing units (RPUs), generating a predictable current output when an input voltage is applied in accordance with a settable resistance.

Certain embodiments herein may offer various technical computing advantages to address problems arising in the realm of computer systems. One such advantage relates to the improvement of computer functionality through the implementation of a semantic attribution framework that allows a computing system to determine—using embeddings and high-dimensional centroid clustering—whether a given output was generated by a specific machine learning model, such as a large language model (LLM), without altering the model's architecture or runtime behavior. This ability to perform a posteriori model attribution constitutes a meaningful improvement to computing technology itself, enabling a computing system to reason about model provenance, enforce policy, and secure model endpoints using non-invasive, inference-compatible vector space comparisons.

Unlike conventional systems that rely on token watermarking, embedded digital signatures, or logging-based heuristics, the present system can operate externally, across black-box or containerized model deployments, allowing attribution capabilities to be deployed as a modular computing service that interacts directly with vectorized representations of both training data and candidate content. By using vector embeddings derived from language models and organizing them into semantic centroids that function as statistical fingerprints of the model's learned representations, manager system 110 enables a technical functionality that was previously unavailable in production LLM workflows—namely, the ability to determine the origin of generated content based on semantic proximity in high-dimensional space, without access to the model's internal weights or architecture. This core capability improves the operational transparency, accountability, and governance of AI systems, providing a new class of computer-implemented functionality for content verification, compliance validation, and misuse detection across distributed infrastructure.

Building on this, manager system 110 can be further configured to support attribution across heterogeneous, multi-domain training corpora by constructing multiple centroids, each corresponding to a semantic subdomain such as legal, medical, technical, or colloquial corpora. In this configuration, rather than generating a single global centroid per model, manager system 110 can perform clustering within the training data's embedding space to derive sub-centroids associated with distinct semantic domains, styles, or topic areas. These domain-specific centroids can allow the system to more accurately attribute documents that contain mixed-language registers or topic transitions, and can improve both the specificity and granularity of attribution analysis.

For example, where a training dataset includes both financial reports and customer support transcripts, manager system 110 can separate those regions in vector space and assign domain-aligned centroids to each, improving the ability to attribute candidate content with fine-grained semantic correspondence. The system may further track domain-specific centroid drift over time to detect fine-tuning or domain adaptation, supporting temporal attribution of content generated at different stages of a model's lifecycle. This multi-centroid, multi-domain framework improves computing functionality by enabling the system to operate with greater precision in semantically diverse environments, and also allows domain-aware policy-based enforcement actions that can be tailored to content risk levels based on the subject matter of the document in question.

Further, the present system offers substantial improvements to the efficiency and resource utilization of computing infrastructure used to train, deploy, and secure LLMs at scale. Manager system 110 can avoid unnecessary compute operations by gating remediation actions based on semantic attribution confidence, determined by configurable distance thresholds in vector space. For instance, if a candidate document's vector embedding falls far outside the radius of any training centroid, manager system 110 can forgo downstream remediation entirely, logging the event as statistically insignificant and thus avoiding the overhead of issuing container restart commands, rotating API keys, or migrating the model to a secure enclave. Conversely, only when attribution confidence is high—e.g., when the document's embedding lies within a defined margin of one or more centroids—does manager system 110 trigger security-sensitive remediation workflows.

These workflows can include instructing model hosting servers 160A-160Z to rehost the model in a hardened VPC, invalidate bearer tokens, enforce geofenced access, or apply container-level lockdown policies. Because these actions are only executed in response to proximity-based triggers, the system avoids wasteful remediation, improving the throughput, uptime, and cost-efficiency of the hosting infrastructure. Moreover, attribution and embedding calculations can be batched, cached, or incrementally updated based on temporal access windows, further reducing system load. In one embodiment, low-confidence proximity events may be placed into deferred evaluation queues for asynchronous review, allowing the system to prioritize high-risk events while still maintaining a long-term record for analytics and policy refinement.

This tiered enforcement model ensures that security interventions are only applied when justified by meaningful statistical correlation, conserving compute cycles, preserving container availability, and reducing unnecessary network I/O. These behaviors collectively improve the computational performance and stability of the hosting platform, enabling intelligent, attribution-aware control of AI infrastructure while minimizing operational friction.

Accordingly, the disclosed system materially advances the state of the art in model attribution, cross-domain content tracking, and compute resource economization, delivering improvements not only in AI governance but in the underlying performance, functionality, and resilience of the computer systems used to deploy and maintain modern machine learning models.

In certain embodiments, the system can further improve computer system functionality by structuring attribution and watermarking operations within a logically distinct test or development environment that is separate from the production model hosting infrastructure. Specifically, manager system 110, in conjunction with its data repository 108, can define a secure watermark storage subsystem that operates independently from the runtime model-serving environment used by model hosting servers 160A-160Z. This subsystem can store the outputs of embedding and clustering operations-such as high-dimensional training embeddings and reference centroids-within a dedicated metrics area of data repository 108, enabling persistent, versioned storage of semantic fingerprint data outside of volatile deployment stacks.

By isolating attribution computation and watermark reference data from live inference environments, the system improves modularity, data integrity, and auditability of model attribution workflows. The secure watermark storage subsystem can be implemented in a controlled staging cluster, virtual sandbox, or hardened internal node designed specifically for attribution fingerprint management, clustering iterations, and semantic proximity analytics, free from the performance constraints of API-serving infrastructure. This separation enables attribution to operate as a standalone computing function, decoupled from the underlying model instance, and allows watermark validation logic to persist across model redeployments, container restarts, or infrastructure migrations.

The result is a materially distinct technical computing architecture in which attribution logic is externalized, maintained, and enforced from a persistent test-layer subsystem defined by manager system 110, improving the reliability, reusability, and security of model governance operations at scale. Certain embodiments may be implemented by use of a cloud platform or data center in various types, including Software-as-a-Service (SaaS), Platform-as-a-Service (PaaS), Database-as-a-Service (DBaaS), and combinations thereof based on types of subscription.

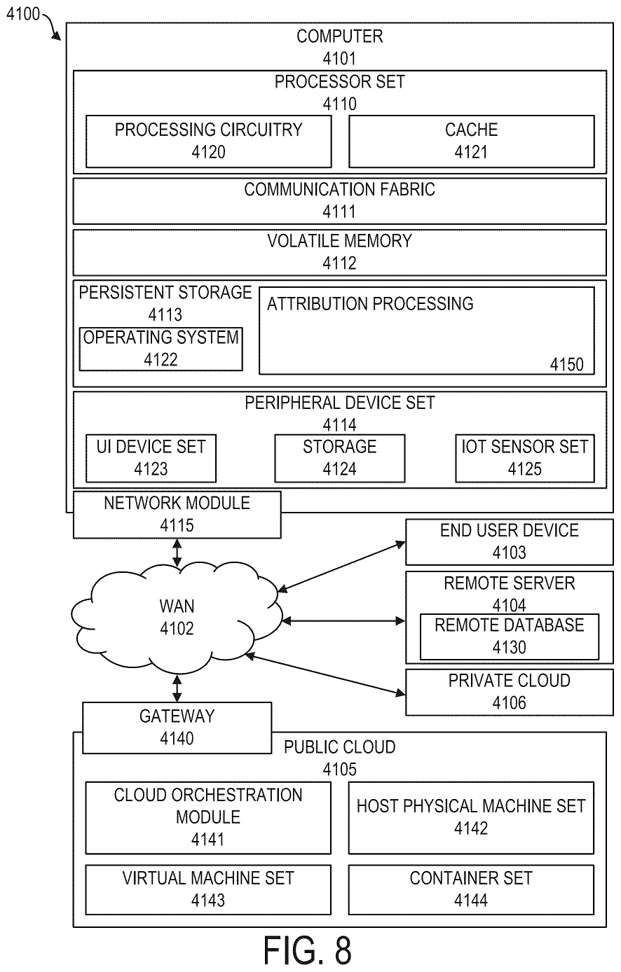

In reference to FIG. 8 there is set forth a description of a computing environment 4100 that can include one or more computer 4101. In one example, a computing node as set forth herein can be provided in accordance with computer 4101 as set forth in FIG. 8.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 8. In one aspect, a computing environment 4100 contains an example of an environment for the execution of at least some of the computer code involved in performing the inventive methods, such as code 4150 for performing attribution processing described with reference to FIGS. 1-7. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IoT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid state storage devices. Operating system 4122 may take several forms, such as various known proprietary operating systems or open source Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101), and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Cloud computing services and/or microservices (not separately shown in FIG. 8): private and public clouds 4106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A method comprising:
embedding training documents used to train the machine learning model to generate training embeddings;
clustering the training embeddings to generate one or more reference centroids, wherein respective ones of the reference centroids represent clusters of semantically similar training embeddings;
deploying the machine learning model to a model hosting server configured to serve model inference requests;
embedding candidate document data to generate one or more candidate embeddings;
comparing the one or more candidate embeddings to the one or more reference centroids using a vector space distance metric; and
presenting an indication that the candidate document data is attributable to the machine learning model based on a result of the comparing.

2. The method of claim 1, wherein the deploying the machine learning model to the model hosting server is performed prior to the clustering of the training embeddings.

3. The method of claim 1, further comprising transmitting the one or more reference centroids to a secure watermark storage subsystem for storage.

4. The method of claim 1, further comprising transmitting the one or more reference centroids to a secure watermark storage subsystem.

5. The method of claim 1, wherein the embedding and clustering comprise generating a respective reference centroid for each training document in the training documents, such that the one or more reference centroids collectively define a fine-grained attribution signature representing document-level semantic structure of a training dataset defined by the training documents, enabling document-level attribution precision.

6. The method of claim 1, wherein the clustering comprises grouping the training embeddings into multiple clusters, each corresponding to a semantically coherent subgroup of a training dataset defined by the training documents, and generating a respective reference centroid for each cluster, thereby forming a multi-centroid attribution profile that captures distinct subject matter domains or writing styles within the training dataset and enables domain-aware attribution.

7. The method of claim 1, wherein the candidate document data comprises a single candidate document, and the determining comprises comparing a vector embedding of the single candidate document to one or more of the reference centroids using the vector space distance metric to determine that the candidate document was generated by the machine learning model.

8. The method of claim 1, wherein the candidate document data comprises a batch of two or more candidate documents, and the determining comprises generating candidate embeddings for the batch, performing clustering on the candidate embeddings to generate a batch centroid, and comparing the batch centroid to the one or more reference centroids using the vector space distance metric to determine that the candidate batch was generated by the machine learning model.

9. The method of claim 1, further comprising initiating a remediation action in response to determining that the candidate document data is attributable to the machine learning model, wherein the remediation action comprises a policy-based enforcement procedure to address suspected unauthorized use of the machine learning model, the enforcement procedure being triggered based on attribution confidence determined from the result of the comparing.

10. The method of claim 1, further comprising initiating a remediation action in response to determining that the candidate document data is attributable to the machine learning model, wherein the remediation action is selected from a tiered set of enforcement responses based on a similarity score derived from the comparing between the one or more candidate embeddings and the one or more reference centroids, the tiered set of enforcement responses selected from a group consisting of: logging the attribution, notifying an enterprise system, invalidating access credentials, and redeploying the machine learning model to a hardened hosting environment with elevated security controls.

11. The method of claim 1, further comprising logging attribution metadata corresponding to the comparing between the one or more candidate embeddings and the one or more reference centroids, wherein the attribution metadata includes one or more of a timestamp, a model identifier, a similarity score, and an attribution determination outcome, and storing the attribution metadata in an audit log.

12. The method of claim 1, further comprising:
embedding additional candidate document data to generate one or more additional candidate embeddings;
comparing the one or more additional candidate embeddings to the one or more reference centroids using a vector space distance metric; and
presenting an indication that the candidate document data is not attributable to the machine learning model based on a result of the comparing.

13. A system comprising:
a memory;
at least one processor in communication with the memory; and
program instructions executable by one or more processor via the memory to perform operations comprising:
embedding a plurality of training documents used to train a machine learning model to generate a plurality of training embeddings;
clustering the plurality of training embeddings to generate one or more reference centroids, wherein respective ones of the reference centroids represent clusters of semantically similar training embeddings;
deploying the machine learning model to a model hosting server configured to serve model inference requests;
embedding candidate document data to generate one or more candidate embeddings;
comparing the one or more candidate embeddings to the one or more reference centroids using a vector space distance metric; and
presenting an indication that the candidate document data is attributable to the machine learning model based on a result of the comparing.

14. The system of claim 13, wherein the deploying the machine learning model to the model hosting server is performed prior to the clustering of the training embeddings.

15. The system of claim 13, further comprising transmitting the one or more reference centroids to a secure watermark storage subsystem for storage.

16. The system of claim 13, further comprising transmitting the one or more reference centroids to a secure watermark storage subsystem.

17. The system of claim 13, wherein the embedding and clustering comprise generating a respective reference centroid for each training document in the training documents, such that the one or more reference centroids collectively define a fine-grained attribution signature representing document-level semantic structure of a training dataset defined by the training documents, enabling document-level attribution precision.

18. The system of claim 13, wherein the clustering comprises grouping the training embeddings into multiple clusters, each corresponding to a semantically coherent subgroup of a training dataset defined by the training documents, and generating a respective reference centroid for each cluster, thereby forming a multi-centroid attribution profile that captures distinct subject matter domains or writing styles within the training dataset and enables domain-aware attribution.

19. The computer-implemented method of claim 1, wherein the candidate document data comprises a batch of two or more candidate documents, and the determining comprises generating candidate embeddings for the batch, performing clustering on the candidate embeddings to generate a batch centroid, and comparing the batch centroid to the one or more reference centroids using the vector space distance metric to determine that the candidate batch was generated by the machine learning model.

20. A computer program product comprising:
a computer readable storage medium readable by one or more processing circuit and storing instructions for execution by one or more processor for performing operations comprising:
embedding a plurality of training documents used to train a machine learning model to generate a plurality of training embeddings;
clustering the plurality of training embeddings to generate one or more reference centroids, wherein respective ones of the reference centroids represent clusters of semantically similar training embeddings;
deploying the machine learning model to a model hosting server configured to serve model inference requests;
embedding candidate document data to generate one or more candidate embeddings;
comparing the one or more candidate embeddings to the one or more reference centroids using a vector space distance metric; and
presenting an indication that the candidate document data is attributable to the machine learning model based on a result of the comparing.
